(19) United States
(12) Patent Application Publication
(10) Pub. No.: US 2009/0217176 A1
(43) Pub. Date: Aug. 27, 2009

(54) METHOD AND SYSTEM FOR MANAGING EVENTS IN AN ELECTRONIC CALENDAR APPLICATION

(76) Inventors: Beatrice Coulomb, Cagnes Sur Mer (FR); Jean-Luc Collet, La Gaude (FR); Gerard Marmigere, Drap (FR); Carole Truntschka, Saint-Laurent-Du-Var (FR)

Correspondence Address: HOFFMAN WARNICK LLC, 75 STATE ST, 14 FL, ALBANY, NY, 12207, US

(21) Appl. No.: 12/361,595

(22) Filed: Jan. 29, 2009

(30) Foreign Application Priority Data
Feb. 27, 2008 (EP) 08305033.6

(51) Int. Cl. G06F 3/048; G06F 15/16

(52) U.S. Cl. 715/751

(57) ABSTRACT

The present invention relates to a method for managing meeting conflicts using user defined priority within a electronic calendar application, and providing history of meeting invitations. When a new meeting is being scheduled, if a conflict exists, the user may set a priority to the meeting. On reschedule or suppress meeting, a priority of overlapped meetings are automatically updated and acceptance is generated for meeting becoming in higher priority. A GUI allows user to modify priority of meetings at any time (accept and “decline with keep me informed” are automatically generated according to new priority).

### FIELD OF THE INVENTION

The present invention relates to data processing, and more particularly, to a method and system for managing events in a multi-media system such as the scheduling of events in an electronic calendar application.

### BACKGROUND ART

Today, many people use electronic calendar applications in data processing systems to schedule meetings. Thus, when a user wants to invite different people to a meeting, the user has to indicate different types of data in a specific request through a request module of the electronic calendar application. The data comprise the date, the time, and the duration of the one or more proposed meetings and the name of the different people required to attend the meeting, etc. Then, the request module has to search the date and the time matching the data of the request in the personal electronic calendars of the people concerned. When the date and the time match the data of the request for most of the people concerned for example except one, there are two alternatives in how electronic calendar application can handle this. The first alternative with a specific electronic calendar application is that the meeting can not be scheduled at all and the user has to suggest other dates, times, and duration. In the second alternative, the electronic calendar sends an invitation to all required attendees. Thus, each required attendee can see the invitation for the meeting on their own calendar and can reply with an acceptance or rejection of the invitation.

If one of the attendees already has a first scheduled meeting for the same time and date, this attendee may have to reject the invitation for the new scheduled meeting, i.e., the second meeting. Therefore, the invitation for this second meeting is deleted from the user's own calendar. However, it may occur that the first scheduled meeting is canceled for some reasons and then the attendee is then available to attend the second meeting that was previously rejected. However, as there is no history of the details and schedule of this second meeting retained in the calendar or elsewhere, the attendee is often unable to retrieve any information relating to the second meeting. Consequently, the attendee can not attend the second meeting if it is still scheduled.

US patent application 2006/095859 discloses a method for detecting an existing conflict between a new meeting invitation and an existing scheduled meeting. Thus, the user does not have to check the calendar for conflicts before entering or accepting a meeting. However, the method only provides such a check for two meetings. The method does not provide any management or any history of all meetings and possible conflicts

### SUMMARY OF THE INVENTION

The present invention provides a method and system which alleviates these and other drawbacks of the prior art. To this extent, the present invention provides a method and system for managing the scheduling of meetings in electronic calendar applications.

According to an aspect of the present invention, there is provided a method of scheduling a meeting between a first electronic calendar application and at least a second electronic calendar application when a new meeting invitation relating to a new meeting occurs from the first electronic calendar application to the at least second electronic calendar application, wherein the new meeting is in conflict with at least one other existing meeting in the at least second calendar application, the at least one existing meeting having one or more priorities associated therewith, the method comprising: receiving the new meeting invitation in the at least second electronic calendar application; identifying a priority of the new meeting to define a priority ranking between the new meeting and the at least one other existing meeting in the at least second electronic calendar application; selecting the meeting with a highest priority ranking as that which should be entered into the at least second electronic calendar application; and storing any meeting that is not the highest priority ranking in a predetermined location for later use.

Another aspect of the present invention provides a computer program for performing the above described method.

A further aspect of the present invention provides a system for performing the steps of the above described method.

A still further aspect of the present invention provides a service deployed in a data processing system for performing the above described method.

### BRIEF DESCRIPTION OF THE DRAWINGS

The novel and inventive features and believed characteristics of the invention are set forth in the appended claims. The invention itself, however, as well as embodiments, further features and advantages thereof, will best be understood by reference to the following detailed description of an illustrative detailed embodiment when read in conjunction with the accompanying drawings.

FIG. 1 is a block diagram of an electronic mail system in a network according to an embodiment of the present invention.

FIG. 2a is a view of a calendar table according to an embodiment of the present invention.

FIG. 2b is a schematic view of a schedule associated with the calendar table according to an embodiment of the present invention.

FIG. 3 is a flow chart of a method for managing the scheduling or events according to an embodiment of the present invention.

FIG. 4 is a flowchart of the method steps for suppressing a meeting invitation according to an embodiment of the present invention.

### DETAILED DESCRIPTION OF THE INVENTION

The following description is presented to enable an ordinary skilled in the art person to make and use the invention. Various modifications to the embodiments and the generic principles and features described herein will be readily apparent to those skilled in the art. Thus, the present invention is not intended to be limited to the embodiment shown but is to be accorded the widest scope consistent with the principles and features described herein.

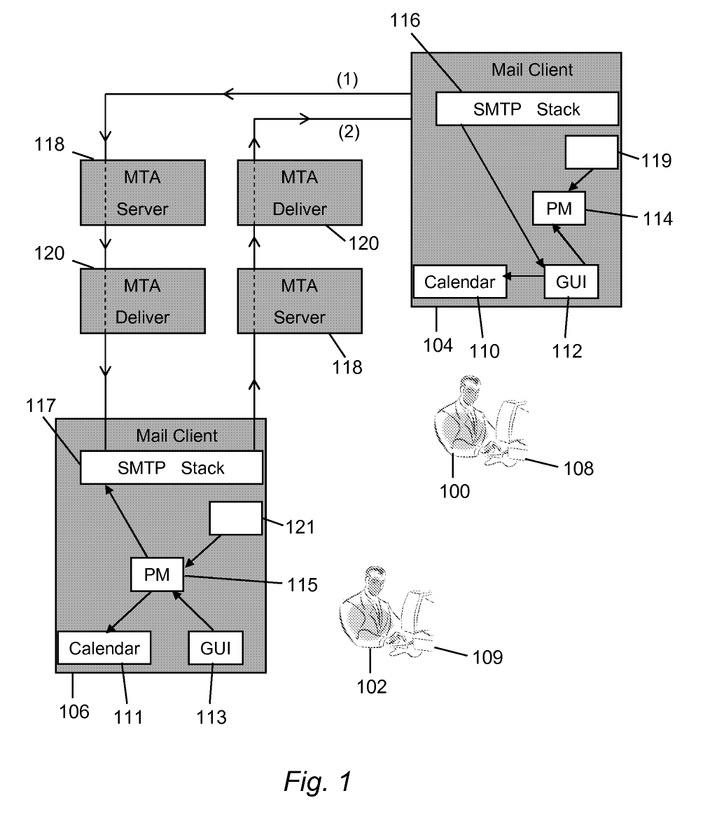

FIG. 1 shows an electronic mail client system or a mail system working over a network. The network may comprise several users such as a sender and one or more receivers. An embodiment of the present invention provides a network comprising, for example, two users, a sender 100 and a receiver 102. Each user 100 or 102 can use a mail client system 104 or 106. The mail client system 104 of the user 100 will now be described. The mail system 106 has the same characteristics as the mail system 104. The user 100 uses a personal computer 108 and the user 102 uses a personal computer 109. The computer 108 hosts a calendar application 110, a Graphical User Interface (GUI) 112, a priority manager (PM) module 114, a meeting queue module for a predetermined location 119 and a Simple Mail Transfer Protocol (SMTP) stack 116. The calendar application 110 provides a calendar as will be described later in order to let the user manage events such as meetings, invitations, reminders, deadlines, etc. The user can enter data relating to such events in the calendar application 110 through the GUI 112. The GUI 112 can be a specific display adapted to receive input data from a user and to set the input data in the calendar. Both calendar application 110 and graphical user interface 112 are connected to the priority manager module 114.

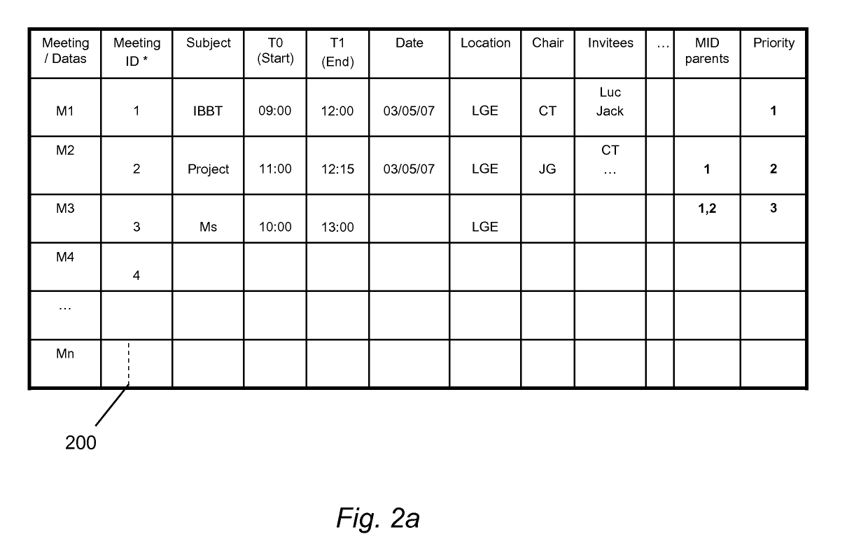

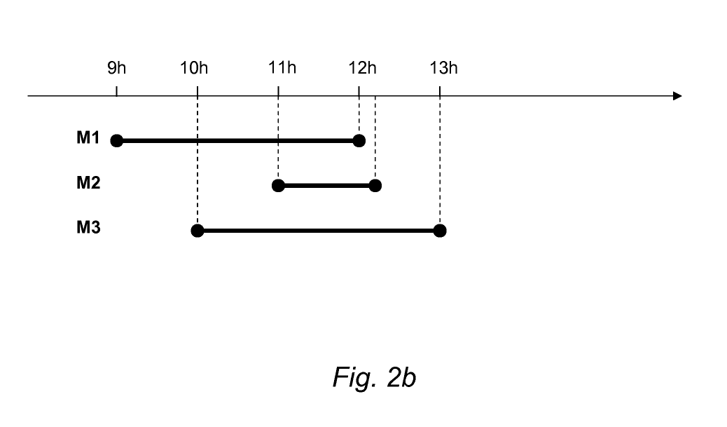

As disclosed in FIG. 2a, the calendar or the meeting table 200 comprises different meeting invitations or table entries. A meeting invitation can give rise to a meeting if the invitation is accepted. A meeting invitation and a meeting are defined with a number of criteria such as a meeting name, Mi where i can have different values such as 1, 2, etc., providing meeting names such as M1, M2, etc., a meeting invitation number 1, 2, 3, etc. A meeting invitation is also defined by a meeting invitation parent number referring to the hierarchical priority related meeting invitation number; a meeting subject; a start and an end time; a date; a location; a chairman; invitees; and a priority number required by the user and referring to the priority of a meeting invitation compared with the priority of another meeting invitation as will be described later. The meeting invitation parent number is allocated to a meeting invitation in order to define the dependency of this meeting invitation with other stored meeting invitations. A meeting invitation number having a priority of 1 refers to a master meeting invitation. A meeting invitation number of 2 or 3, etc., refers to a meeting invitation having a lower priority than a master meeting invitation.

These criteria refer to already stored meeting invitations in the meeting queue module. Each time the mail client system receives a new meeting invitation, a specific process has to occur to schedule the new invitation based on the one or more already stored meeting invitations. The priority manager module 114 is connected to the meeting queue module 119. The meeting queue module 119 stores a list, namely a meeting queue list, which is a list of meeting invitations already stored, each meeting invitation having a defined priority level as shown in FIG. 2a. The meeting queue list is an extract of the calendar 200. The determination of the priority level for new received meeting invitation will be defined later. FIG. 2b shows a schedule of the calendar table of FIG. 2a where meetings invitation M1 and M2 have a conflict for the time 11 h to 12 h, M1 and M3 have a conflict for the time 10 h to 12 h, and M2 and M3 have a conflict for the time 11 h to 12 h. As described in FIG. 2a, M1 has a priority of 1, therefore the user associated with such a calendar should preferably attend the meeting M1.

The mail client system 104 also comprises an SMTP stack 116. The stack 116 transfers information from the priority manager module 114 to the outside of the mail client system 104.

The mail client system 104 is connected to a Mail Transfer Agent (MTA) server 118 connected to a MTA deliver server 120. On a first route (1), the MTA deliver server 120 transfers information from the MTA server 118 to the mail client system 106 of the user 102 through the SMTP stack 117. On a second route (2), the MTA deliver server 120 transfers information from the MTA server 118 to the mail client system 104 of the user 100 through the SMTP stack 116. The mail client system 106 comprises the same components as the mail client system 104, i.e., a calendar application 111, a GUI 113, a priority manager module 115, a SMTP stack 117 and a meeting queue module 121. The user 102 owns a calendar or a meeting table such as the calendar 200. Each time a new meeting invitation reaches the mail client system 104 or 106, a specific process occurs to schedule the new invitation meeting based on the already stored meeting invitation as described below.

The process of the present invention will now be described with reference to the following steps.

At first, the user 100 sends a meeting invitation to the user 102 through the mail client system 104. Thus, the meeting invitation reaches the SMTP stack 117 of the mail client 106 of the user 102 through the MTA server 118 and the MTA deliver server 120. The MTA deliver server 120 or the receiving module receives and transfers the meeting invitation to the client mail system of the user 102 and puts the meeting invitation into the calendar application 111. As soon as the user 102 receives the meeting invitation on his mail client system 106, the priority manager module 115 begins a scheduling process.

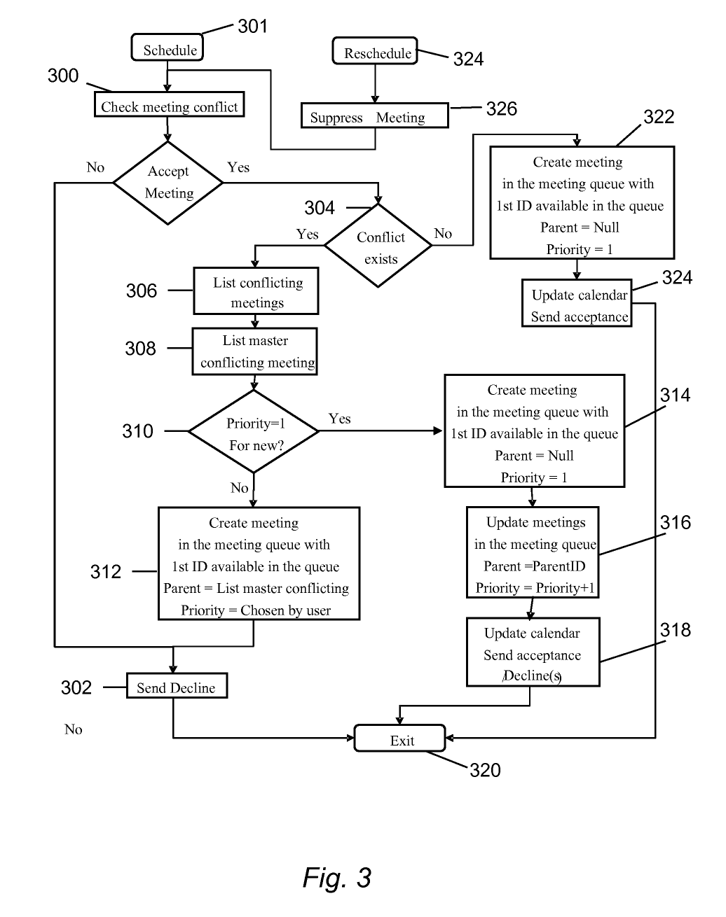

As shown in FIG. 3, in a step 300 the priority manager module 115 checks if the new meeting invitation is in conflict with another meeting already stored in the meeting queue 121.

A conflict may occur for at least two meetings having the same date and the same starting time for example. If the user 102 does not want to attend the meeting, the priority manager module 115 sends a decline instruction to the mail client system 104 of the user 100 in step 302.

If the user wants to attend the meeting, the priority manager module 115 accepts the meeting and specifically checks any potential conflict with meeting invitations already stored in the meeting queue module 121 in a step 304.

If conflicts exist (Yes, 304), the priority manager module 115 uses a priority ranking module (not shown) belonging to the priority manager module to identify or list all the conflicting meeting invitations in a step 306. Then, in a step 308, in the list of the conflicting meetings the priority manager module 115 only selects with a priority selecting module belonging to the priority manager module the conflicting meetings having a priority number equal to 1, i.e., the master conflicting meeting. Then in a step 310, the user has to decide if the priority of 1 for the conflicting meeting should be kept to 1 or if a priority of 1 should be affected to the new received meeting invitation with a priority ranking module.

If the user does not want to change the priority of 1 already allocated to the previous stored meeting invitation (No, 310), then the priority manager module 115 processes the new meeting invitation as shown in step 312. The priority manager module 115 uses a priority storing module belonging to the priority manager module 115 to add the new meeting invitation in the meeting queue or the predetermined location 121 by allocating the first available invitation number to the new meeting invitation. Then the user has to choose the priority number of the new meeting invitation among values other than 1. Thus, the priority manager module uses a dependency ranking module belonging to the priority manager module 115 in order to attribute to the new meeting invitation the number of master conflicting meeting invitations as parents. After the step 312, the priority manager module 115 uses a decline notification module belonging to the priority manager module 115 to send a decline instruction to the user 100 in the step 302. The user 102 uses a decline instruction to indicate to the user 101 that the user 102 will not attend the corresponding meeting. The decline instruction also indicates that the user still wants to receive update information relating to the corresponding meeting in order to be able to attend the meeting in case of any cancellation of other meetings having a higher priority than the corresponding meeting. Thus, the user 102 declines the new meeting invitation from the user 100 and the user can exit the calendar database as shown in step 320. However, the user 102 still keeps all the details of the new meeting in the database. The use of the database allows the user 102 to keep an historic record of all meeting invitations. Therefore, if the master conflicting meeting is canceled, the priority number of the new meeting invitation may change and the new priority number may imply that the user 102 can send an acceptance instruction to the user 100 for the new invitation meeting as will be described later.

In step 310, if the user 102 wants to attribute a priority equal to 1 to the meeting invitation (Yes, 310), the priority manager module 115 allocates the priority of 1 to the new meeting invitation. As the priority number equals to 1, the meeting invitation does not depend on any other meeting invitation, therefore the priority manager module 115 does not attribute any parents number to this meeting invitation as shown in step 314.

Then, in step 316, the priority manager module 115 consequently updates the database by changing the priority of each already stored meeting invitation respective by incrementing with 1 their priority numbers. Therefore, the increment of the new priority number equals to 1 lowers the priority levels of the corresponding stored meeting invitations. The priority manager module 115 also updates the allocation of parent numbers to all the already stored meeting invitations.

In a step 318, the priority manager module 115 uses an acceptance notification module belonging to the priority manager module 115 to send an acceptance instruction to the user 100 regarding the new meeting invitation as an acknowledgment. Consequently, the priority module 115 also sends a decline instruction to the user 100 for meeting invitations having now a lower priority level as described above. Then the user can exit the calendar application.

In step 304, if the calendar application detects no existing conflicts (No, 304), then the priority manager module 115 adds the new meeting invitation to the meeting queue module 121 with a priority number of 1 and with no allocated parent number as shown in step 322. The calendar database is then updated.

Then, in step 324, the priority manager sends an acceptance instruction to the user 100. The user 102 exits the calendar application as shown in step 320.

Another situation may occur where the user 100 would like to reschedule a meeting already stored in the meeting queue of the calendar database of the user 102. Then the user 102 has to suppress the corresponding meeting as shown in step 326 before beginning the process of scheduling of step 301. The meeting invitation to suppress is called removed meeting invitation, i.e., RM invitation with a specific value i such as 1, 2, 3, etc., to define and identify the meeting invitation name or meeting invitation identifier to suppress. The RM invitation comprises a removed meeting priority number a removed meeting parent numbers.

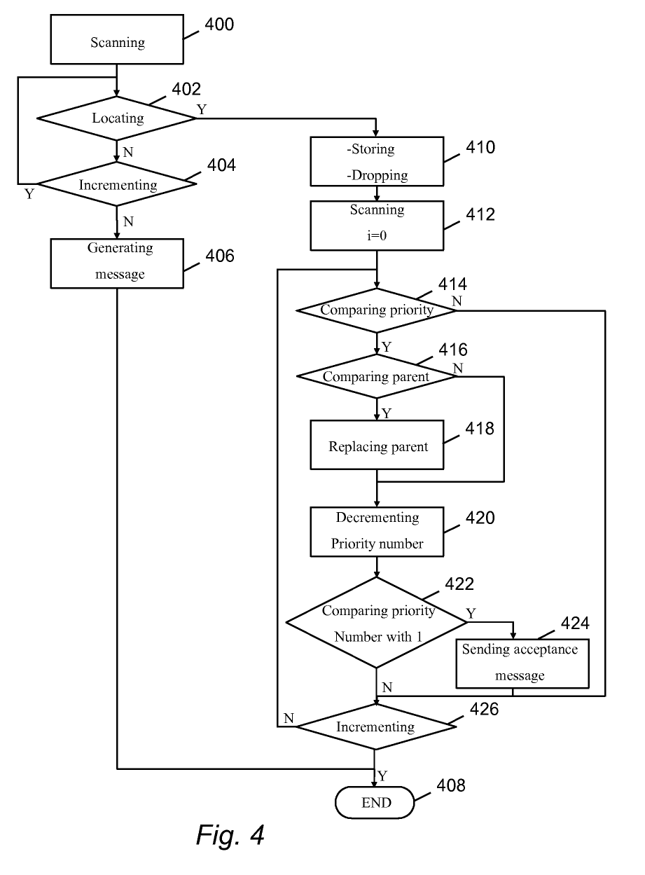

The process of suppressing a meeting invitation is represented in FIG. 4 where the priority manager module uses a meeting removing module. In a step 400, the priority manager module 115 scans the meeting table 200 of the user 202 in order to find the removed meeting invitation to suppress. The current table entry is scanned to determine if the corresponding meeting invitation name relates to the removed meeting invitation as shown in step 402. If the current entry corresponds to the removed meeting invitation (Yes, 402), both the removed meeting invitation priority number and the removed meeting invitation parent number are stored for later use as shown in step 410. At the same time the current entry which corresponds to the removed meeting invitation is dropped from the meeting table 200 and the process continues with step 412 as will be described below. If the removed meeting invitation is not found in step 402 (No, 402), then the value of i is incremented by 1 to pass to the next table entry as shown in step 404. If the table entry which corresponds to such an increment refers to an entry in the meeting invitation table, then the process will return to step 402. The process will stop if no table entry is found or located that corresponds with the removed meeting invitation. Therefore, as shown in step 406 a specific message, e.g., “Meeting invitation not found” is generated and then the suppress meeting procedure is ended as shown in step 408. As indicated above, if a meeting invitation which corresponds to the removed meeting invitation is found in the meeting table (Yes, 402), the step 410 occurs. Further scanning of the meeting table occurs as shown in step 412. In this step 412, the value of i is set initially to 0. Then in step 414, a priority comparison module belonging to the priority manager module 115 processes a comparison between the priority number of the located meeting invitation and the removed meeting invitation priority number. If the priority number of the meeting invitation found is lower than the priority number of the removed meeting invitation (No, 414), then the located meeting invitation is not impacted by the suppression of the removed meeting invitation. Thus, the process continues in step 426 to explore the next meeting invitation in the meeting table. In step 426 the next table entry is analyzed after an increase of 1 for i. The process will return to step 414 until i is greater than the meeting table size. When i exceeds the table size (Yes, 426), then the suppress meeting process is ended as shown in step 408. If in step 414, the priority number of the located meeting invitation is higher than the priority number of the removed meeting invitation (Yes, 414), then a dependency comparison module belonging to the priority manager module processes a comparison between the parent number of the located meeting invitation and the removed meeting invitation identifier. If both parent numbers and removed meeting invitation identifier are equal (Yes, 416), then the parent number specified in the meeting table for the located meeting invitation is replaced, in step 418, by parent number of the removed meeting invitation as shown in step 410. Then, in both situations whether the parent numbers are equal or not, the priority number of the located meeting invitation is decreased by 1 as shown is step 420. If the amended priority number of the located meeting invitation is now equal to 1 as shown in step 422 (Yes, 422), (which means that the removed meeting invitation had the highest priority) the removed meeting is replaced by the located meeting invitation. Therefore, a recovery module belonging to the priority manager module process the located meeting invitation to reintroduce the located meeting invitation into the electronic calendar of the user 102. In step 424, an acceptance message is sent to the chair or initiator of the meeting and the meeting table is updated. In step 426 the next table entry is analyzed after an increase of 1 for i. The process will return to step 414 until i is greater than the meeting table size. When i exceeds the value of the meeting table size (Yes, 426) then the suppress meeting process is ended as shown in step 408.

Priority modules 114 and 115 include the same following modules as described above: a receiving module, a priority ranking module, a priority selecting module, a priority storing module, an acceptance notification module, a decline notification module, a dependency ranking module, a meeting suppress module, a priority comparison module and a dependency comparison module.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appending claims.

1. A method of scheduling a meeting between a first electronic calendar application and at least a second electronic calendar application when a new meeting invitation relating to a new meeting occurs from the first electronic calendar application to the at least second electronic calendar application, wherein the new meeting is in conflict with at least one other existing meeting in the at least second calendar application, the at least one existing meeting have one or more priorities associated therewith, the method comprising:
receiving the new meeting invitation in the at least second electronic calendar application;
identifying a priority of the new meeting to define a priority ranking between the new meeting and the at least one other existing meeting in the at least second electronic calendar application;
selecting the meeting with a highest priority ranking as the meeting which should be entered into the at least second electronic calendar application; and
storing any meeting that is not the highest priority ranking in a predetermined location for later use.

2. The method as claimed in claim 1, further comprising:
sending a notification to the first calendar application to acknowledge attendance of the meeting having the highest priority ranking.

3. The method as claimed in claim 1, further comprising:
sending a notification to the first calendar application to acknowledge non-attendance of each meeting that is not the highest priority ranking.

4. The method as claimed in claim 1, further comprising:
identifying a dependency ranking between meetings for one or more meetings in the at least second electronic calendar application based on the priority ranking.

5. The method as claimed in claim 1, further comprising:
removing the meeting from the at least second electronic calendar application.

6. The method as claimed in claim 5, wherein removing the meeting further comprises:
reintroducing a meeting from the predetermined location into the at least second electronic calendar.

7. The method as claimed in claim 6, wherein reintroducing the meeting further comprises:
comparing priority ranking of each meeting in the predetermined location; and
selecting the meeting with the highest priority ranking as the meeting that should be reintroduced into the calendar.

8. A computer program product stored on a computer readable medium, the program product comprising program code for performing a method of scheduling a meeting between a first electronic calendar application and at least a second electronic calendar application when a new meeting invitation relating to a new meeting occurs from the first electronic calendar application to the at least second electronic calendar application, wherein the new meeting is in conflict with at least one other existing meeting in the at least second calendar application, the at least one existing meeting have one or more priorities associated therewith, the method comprising:
receiving the new meeting invitation in the at least second electronic calendar application;
identifying a priority of the new meeting to define a priority ranking between the new meeting and the at least one other existing meeting in the at least second electronic calendar application;
selecting the meeting with a highest priority ranking as the meeting which should be entered into the at least second electronic calendar application; and
storing any meeting that is not the highest priority ranking in a predetermined location for later use.

9. The program product as claimed in claim 8, wherein the method further comprises:
sending a notification to the first calendar application to acknowledge attendance of the meeting having the highest priority ranking.

10. The program product as claimed in claim 8, wherein the method further comprises:
sending a notification to the first calendar application to acknowledge non-attendance of each meeting that is not the highest priority ranking.

11. The program product as claimed in claim 8, wherein the method further comprises:
identifying a dependency ranking between meetings for one or more meetings in the at least second electronic calendar application based on the priority ranking.

12. The program product as claimed in claim 8, wherein the method further comprises:
removing the meeting from the at least second electronic calendar application.

13. The program product as claimed in claim 12, wherein removing the meeting further comprises:
reintroducing a meeting from the predetermined location into the at least second electronic calendar.

14. The program product as claimed in claim 13, wherein reintroducing the meeting further comprises:
comparing priority ranking of each meeting in the predetermined location; and
selecting the meeting with the highest priority ranking as the meeting that should be reintroduced into the calendar.

15. A data processing system for scheduling a meeting between a first electronic calendar application and at least a second electronic calendar application when a new meeting invitation relating to a new meeting occurs from the first electronic calendar application to the at least second electronic calendar application, wherein the new meeting is in conflict with at least one other existing meeting in the at least second calendar application, the at least one existing meeting have one or more priorities associated therewith, the data processing system comprising:
a system for receiving the new meeting invitation in the at least second electronic calendar application;
a system for identifying a priority of the new meeting to define a priority ranking between the new meeting and the at least one other existing meeting in the at least second electronic calendar application;
a system for selecting the meeting with a highest priority ranking as the meeting which should be entered into the at least second electronic calendar application; and
a system for storing any meeting that is not the highest priority ranking in a predetermined location for later use.

16. A service deployed in a data processing system for scheduling a meeting between a first electronic calendar application and at least a second electronic calendar application when a new meeting invitation relating to a new meeting occurs from the first electronic calendar application to the at least second electronic calendar application, wherein the new meeting is in conflict with at least one other existing meeting in the at least second calendar application, the at least one existing meeting have one or more priorities associated therewith, the service providing a method comprising:
receiving the new meeting invitation in the at least second electronic calendar application;
identifying a priority of the new meeting to define a priority ranking between the new meeting and the at least one other existing meeting in the at least second electronic calendar application;
selecting the meeting with a highest priority ranking as the meeting which should be entered into the at least second electronic calendar application; and
storing any meeting that is not the highest priority ranking in a predetermined location for later use.
